(19) United States
(12) Patent Application Publication
(10) Pub. No.: US 2019/0171421 A1
(43) Pub. Date: Jun. 6, 2019

(54) Method, Apparatus and Computer Program for Reducing Variability Model

(71) Applicant: Bayerische Motoren Werke Aktiengesellschaft, Muenchen (DE)

(72) Inventor: Walter HIPP, Kottgeisering (DE)

(21) Appl. No.: 16/272,571

(22) Filed: Feb. 11, 2019

Related U.S. Application Data
(63) Continuation of application No. PCT/EP2016/069264, filed on Aug. 12, 2016.

(51) Int. Cl. G06F 8/20; G06F 9/448; G06F 8/35

(52) U.S. Cl. CPC G06F 8/24; G06F 8/35; G06F 9/449

(57) ABSTRACT

A method is suitable for reducing a variability model based on a base model, the variability model and a meta model. The base model comprises a plurality of objects and a first plurality of relationships between objects of the plurality of objects. The variability model comprises a plurality of variation points. A variation point describes an option within an object of the plurality of objects. The plurality of variation points are related to the plurality of objects by a second plurality of relationships between the plurality of variation points and the plurality of objects. The meta model comprises a plurality of constraints related to the plurality of variation points. The method includes reducing the variability model by calculating implicit relationships between the plurality of variation points based on the plurality of constraints of the meta model, identifying a subset of variation points of the plurality of variation points implied by other variation points of the plurality of variation points based on the implicit relationships, and removing variation points of the subset of variation points from the plurality of variation points and the variability model.

### CROSS REFERENCE TO RELATED APPLICATION

This application is a continuation of PCT International Application No. PCT/EP2016/069264, filed Aug. 12, 2016, the entire disclosure of which is herein expressly incorporated by reference.

### BACKGROUND AND SUMMARY OF THE INVENTION

Embodiments relate to a method, an apparatus and a computer program for reducing a variability model, more specifically, but not exclusively, based on relationships defined by a meta model.

Many types of software comprise a multitude of different components. For example, software used in systems used to control machines, may comprise a plurality of components, which may control a plurality of features or aspects of the machine. If there are different versions of the machine, different components may be used for the software, e.g. to accommodate different feature sets of the machine. To generate software fitting a specific machine (or sub-component of the machine), an object model, which may comprise components for all versions of the machine, may be reduced to obtain a model to model the features and aspects of the specific machine. As there may be a huge variety of machines (e.g. different car models of a car manufacturer, which themselves offer a multitude of options), reducing such models may be complex and error-prone.

There may be a demand for an improved concept for a processing of object models, to reduce a complexity of subsequent transformations of the object model and to reduce or avoid possible consistency issues during further processing of the object model.

Such a demand may be satisfied by the subject matter of the claims.

Some embodiments relate to a method for reducing a variability model. The variability model comprises a plurality of variation points. The reduction of the variability model may be based on information that is redundantly stored in the variability model and in a meta model comprising constraints regarding the variability model. If the meta model comprises a constraint that describes an implication of one variation point of the plurality of variation points on another variation point of the plurality of variation point, that variation point may be omitted, leading to a reduction of the variability model. During further processing of the variability model (e.g. during model transformation or generation of a composite software), the information comprised in the meta model may be used in place of the variation points omitted in the variability model.

Embodiments provide a method for reducing a variability model based on a base model, the variability model and a meta model. The base model comprises a plurality of objects and a first plurality of relationships between objects of the plurality of objects. The variability model comprises a plurality of variation points. A variation point describes an option within an object of the plurality of objects. The plurality of variation points are related to the plurality of objects by a second plurality of relationships between the plurality of variation points and the plurality of objects. The meta model comprises a plurality of constraints related to the plurality of variation points. The method comprises reducing the variability model by calculating implicit relationships between the plurality of variation points based on the plurality of constraints of the meta model. The reducing of the variability model further comprises identifying a subset of variation points of the plurality of variation points implied by other variation points of the plurality of variation points based on the implicit relationships. The reducing of the variability model further comprises removing variation points of the subset of variation points from the plurality of variation points and the variability model.

The reduction of the variability model may facilitate the creation of a consistent model during model transformation, and may reduce a calculation complexity and memory usage during further processing.

In at least some embodiments, the plurality of variation points may comprise a plurality of variation components and a plurality of variation component types related to the plurality of variation types. The plurality of constraints may indicate relationship between variation components of the plurality of variation components and variation component types of the plurality of variation types. The calculating of the implicit relationships may be based on the relationships between variation components of the plurality of variation components and variation component types of the plurality of variation types indicated by the plurality of constraints. A removal of the variation component types indicated by the constraints comprised in the meta model may enable a (significant) reduction of the variability model.

In various embodiments, the method may further comprise removing relationships of the second plurality of relationships related to variation points comprised in the subset of variation points and not related to variation points (of the plurality of variation points) not comprised in the subset of variation points from the second plurality of relationships. The remove of relationships may further facilitate the creation of a consistent model during model transformation, and may reduce a calculation complexity and memory usage during further processing.

In at least some embodiments, the method may further comprise reducing the variability model based on one or more explicit choices related to the variation points of the plurality of variation points. Further reducing the variability model by replacing variation points with explicit (or implicit) choices may further reduce the variability model and thus facilitate the creation of a consistent model during model transformation, reduce a calculation complexity and memory usage during further processing.

The method may further comprise obtaining information related to one or more root objects of the plurality of objects of the base model. The method may further comprise identifying objects of the plurality of objects related to the one or more root objects of the base model based on first plurality of relationships. The method may further comprise calculating variation resolutions for a subset of variation points of the plurality of variation points (at least) related to objects of the plurality of objects related to the one or more root objects of the base model (the one or more root objects may be at least related to the one or more root objects, for example). The method may further comprise calculating variation resolutions for implicit variation points implied by the plurality of constraints and variation points of the plurality of variation points related to objects of the plurality of objects related to the one or more root objects of the base model. The method may further comprise adding the variation resolutions for the subset of variation points and variation resolutions for implicit variation points to the objects of the plurality of objects related to the one or more root objects of the object model. The method may further comprise removing the resolved variation points from the plurality of variation points. Reducing/transforming the object based on variation resolution and based on the one or more root objects may create a reduced and consistent object model having a reduced variability model. This may result in a reduced calculation complexity and memory usage.

In various embodiments, the method may be suitable for a generation of composite software from a plurality of software components. The method may further comprise generating the composite software based on the objects of the plurality of objects related to the one or more root objects, variation points of the variability model related to the objects of the plurality of objects related to the one or more root objects and based on the meta model. The generation of the composite software based on the reduced model may enable a successful generation of the composite software, e.g. with fewer resource than with an un-reduced model.

For example, the obtaining of the information related to one or more root objects may be based on one or more explicit choices related to the plurality of objects. Explicit choice may enable a reduction of the model, e.g. to exclude variants excluded by the one or more explicit choices.

For example, the identifying of the objects of the plurality of objects related to the one or more root objects may be based on a mapping between objects. The mapping between objects (e.g. references or bindings expressing a cardinality of a relationship between objects) may be used to identify the objects related to the root objects.

In example, the calculating of the variation resolutions for the subset of variation points and/or the calculating of the variation resolutions for the implicit variation points may be based on one or more explicit choices related to the subset of variation points and/or related to the implicit variation points. The one or more explicit choices may enable reducing variability within the model, e.g. by removing variation points resolved by the one or more explicit choices.

For example, the calculating of the variation resolutions for the subset of variation points and/or the calculating of the variation resolutions for the implicit variation points may be based on one or more variation constraints related to the subset of variation points and/or related to the implicit variation points. For example, the variation constraints may lead to an implicit resolution (as no other resolution may be possible due to the constraints) of the variation points.

For example, the calculating of the variation resolutions for the subset of variation points and/or the calculating of the variation resolutions for the implicit variation points may comprise deriving choices. The derivation of choices may derive implicit choices from explicit choices and constraints, for example.

For example, the deriving of choices may be based on at least one of choice implication, choice exclusion and parent-child relation. The derivation of choices may derive implicit choices from explicit choices and constraints related to choice implication, choice exclusion and parent-child relation, for example.

For example, a variation point may comprise two or more choice options. The deriving of choices may be based on an upper limit or a lower limit of selectable options for the two or more choice options. This may enable a deriving of choice if enough, too many or too few choice options have been selected.

For example, the identifying of the objects of the plurality of objects related to the one or more root objects may be further based on parent-child-relationships of the previously identified objects of the plurality of objects related to the one or more root objects. The parent-child-relationships might not be explicitly comprised in the plurality of relationships between objects, for example.

For example, the method may further comprise moving the variation resolution and/or variation points, for which a variation resolution is calculated, from the variability model to the base model. This may enable a further reduction of the variability model.

For example, the method may further comprise removing an object of the plurality of objects and/or an object of the objects related to the one or more root objects based on one or more model constraints. For example, the model may be further reduced, if model constraints implicate or disallow further objects comprised in the model.

For example, the method may further comprise removing objects of the plurality of objects not related to the one or more root objects. This may reduce the object model to objects required for further transformation or for the generation of software.

For example, an object model comprising the base model (and the variability model and/or the meta model, for example) may describe a plurality of variants of a vehicle or of a vehicle component.

Embodiments further provide a computer program having a program code for performing the above method, when the computer program is executed on a computer, a processor, or a programmable hardware component. A further embodiment is a computer readable storage medium storing instructions which, when executed by a computer, processor, or programmable hardware component, cause the computer to implement one of the methods described herein.

Embodiments further provide an apparatus for reducing a variability model based on a base model, the variability model and a meta model. The base model comprises a plurality of objects and a first plurality of relationships between objects of the plurality of objects. The variability model comprises a plurality of variation points. A variation point describes an option within an object of the plurality of objects. The plurality of variation points are related to the plurality of objects by a second plurality of relationships between the plurality of variation points and the plurality of objects. The meta model comprises a plurality of constraints related to the plurality of variation points. The apparatus comprises a storage module configured to store the base model, the variability model and the meta model. The apparatus further comprises a control module configured to reduce the variability model by calculating implicit relationships between the plurality of variation points based on the plurality of constraints of the meta model. The control module is further configured to identify a subset of variation points of the plurality of variation points implied by other variation points of the plurality of variation points based on the implicit relationships. The control module is further configured to remove variation points of the subset of variation points from the plurality of variation points and the variability model.

Some other features or aspects will be described using the following non-limiting embodiments of apparatuses or methods or computer programs or computer program products by way of example only, and with reference to the accompanying figures, in which:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a flow chart of a method for reducing a variability model.

FIG. 1a illustrates a flor chart of a method for generating a resolved base model.

FIG. 2 illustrates a block diagram of an embodiment of an apparatus for reducing a variability model.

FIG. 3a-3e show code fragments according to an embodiment.

### DETAILED DESCRIPTION OF THE DRAWINGS

Various example embodiments will now be described more fully with reference to the accompanying drawings in which some example embodiments are illustrated. In the figures, the thicknesses of lines, layers or regions may be exaggerated for clarity. Optional components are illustrated using broken, dashed or dotted lines.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the invention. Like numbers refer to like or similar elements throughout the description of the figures.

As used herein, the term, “or” refers to a non-exclusive or, unless otherwise indicated (e.g., “or else” or “or in the alternative”). Furthermore, as used herein, words used to describe a relationship between elements should be broadly construed to include a direct relationship or the presence of intervening elements unless otherwise indicated. For example, when an element is referred to as being “connected” or “coupled” to another element, the element may be directly connected or coupled to the other element or intervening elements may be present. In contrast, when an element is referred to as being “directly connected” or “directly coupled” to another element, there are no intervening elements present. Similarly, words such as “between”, “adjacent”, and the like should be interpreted in a like fashion.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” or “including,” when used herein, specify the presence of stated features, integers, steps, operations, elements or components, but do not preclude the presence or addition of one or more other features, integers, steps, operations, elements, components or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Variation handling (in object models) may be done by imposing a variability model on top of an existing base model. The base model may comprise payload data whereas (all kind of) variation information may typically be defined within the variability model. The variability model may be used for variant selection and resolution and the result may then be applied to the base model during a materialization step.

In other systems, a strict separation between variability and base model may have some systematic drawbacks for model-based systems. At least some embodiments may be based on combining information of both models for variant resolution, as the base model, respectively its meta model, may already comprise (a lot of) information that is relevant for variation handling.

At least some exemplary embodiments may be based on an Eclipse Modelling Framework (EMF), containing an Ecore meta model, a corresponding model and Xtend transformation scripts. Variation may be described in terms of the common variability language (CVL). The approach is however not dependent on a specific framework or variability language. All terms and examples are used by way of illustration.

Models (e.g. a base model) may comprise objects O and references R between objects Oi - - - R - - - Oj. References may have cardinalities for both sides. A reference may be mandatory if the cardinality is greater or equal to one. A special reference may be the one between parent and child objects, which may be an aggregation or a composition. A composition reference may also be a mandatory reference from point of view of the child object.

EMF allows to define Ecore meta models and to process corresponding models. Transformers for model-to-model or model-to-code transformations may e.g. be written in Xtend.

There are different possibilities to express variation information. In CVL, base model objects may have variation points. Those variation points may be bound to VSpecs (Variation Specifications). An example may be an ObjectExistence variation point that is bound to a Choice VSpec. Another example may be a SlotAssignment that is bound to a Variable. Variation points and VSpecs may be comprised in the variation model.

For efficient variation handling, constraints may be useful as they reduce the number of decisions that have to be taken explicitly. A Choice may e.g. imply or exclude another Choice. Or there might a limitation for the number of selectable Choices within a group. Constraints may also be comprised in the variability model, for example. Derivations may be defined for all kinds of VSpecs, for example.

At least some embodiments may enable variation resolution. The resolution model may for example comprise (VSpec) resolutions, e.g. yes/no decisions for choices or values for variables. The process of transforming a base model to a product model is called materialization. During materialization, the variation points within the base model may be applied (resolved) by taking into account the resolution and the variability models. Variation resolution may cover the process of defining or computing a resolution model and materialization.

After variation resolution, follow-up actions may take place, which may generally be described by model transformations. A model transformation may be based on a common meta model (inplace transformation), on two or more different meta models (model-to-model transformation) or on transformation to non-model-based artefacts, e.g. code. Transforming a model may imply to also transform the variation objects.

Variation resolution may comprise an iterative process as VSpecs may have different resolution times. In general, there may be a partial variation resolution, followed by a model transformation, followed again by a partial variation resolution (and so on) until the final product model or artefact has been generated. The approach used in embodiments may be applied to (all) resolution steps that depend on model-based artefacts. For example, there might be no restrictions in regards to iterations.

For each resolution step, the set of relevant decisions may differ. For example, a base model may describe a system of systems. A first resolution step might resolve variation that is related to inter-system communication. Then, in a second step, remaining variation may be resolved for a single system. The result may comprise of specialized product models that each describe a single system.

Other feature modelling approaches may comprise identifying variation points and creating variation objects for all of them. If there is e.g. a variable Attribute and a variable AttributeType, both of them may be identified as variation points. There may be two ObjectExistence objects for them and possibly a common Choice to which they are bound.

This may lead to a large number of variation objects. Great care may need to be taken when creating the variability model in order to ensure that the resulting product model is consistent. There may be a high chance that the model becomes inconsistent as referenced objects may have been deleted. There may also be a high chance that the product model may comprise unneeded objects. In addition, variability might (only) be modelled for objects that exist in the initial base model. Objects created by model transformations in between resolution steps might not be taken into account.

Embodiments may be based on reducing or minimizing the number of objects in the variability model and instead to focus on existing base model relations and constraints. For the given example, there might be a variation point only for the Attribute, not for the AttributeType. If the object is selected, so may be the AttributeType. If there is no Attribute that uses the AttributeType, it may be removed.

The variability model may be reduced to variation information that might not be derived from an existing relation or constraint of the underlying base model. As base model constraints become an integral part of variation resolution, there may be a higher chance that the product model is consistent. Furthermore, redundancy between variability model and base model may be reduced and it may be simple to get rid of unused objects. The assumption might be that the majority of information that is relevant for variation handling is already contained in the base model.

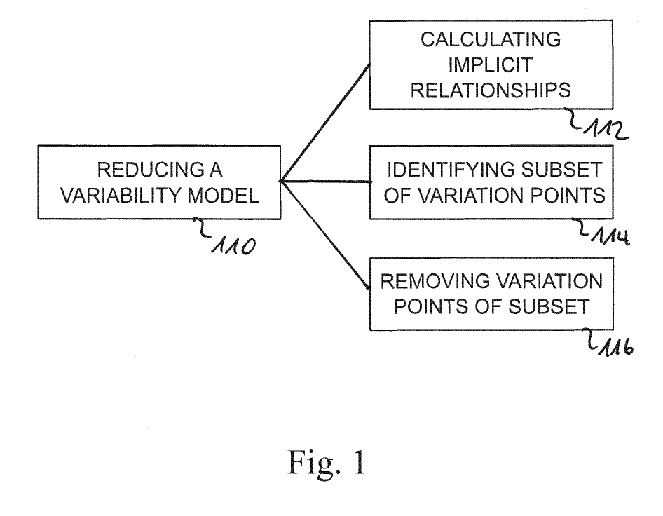

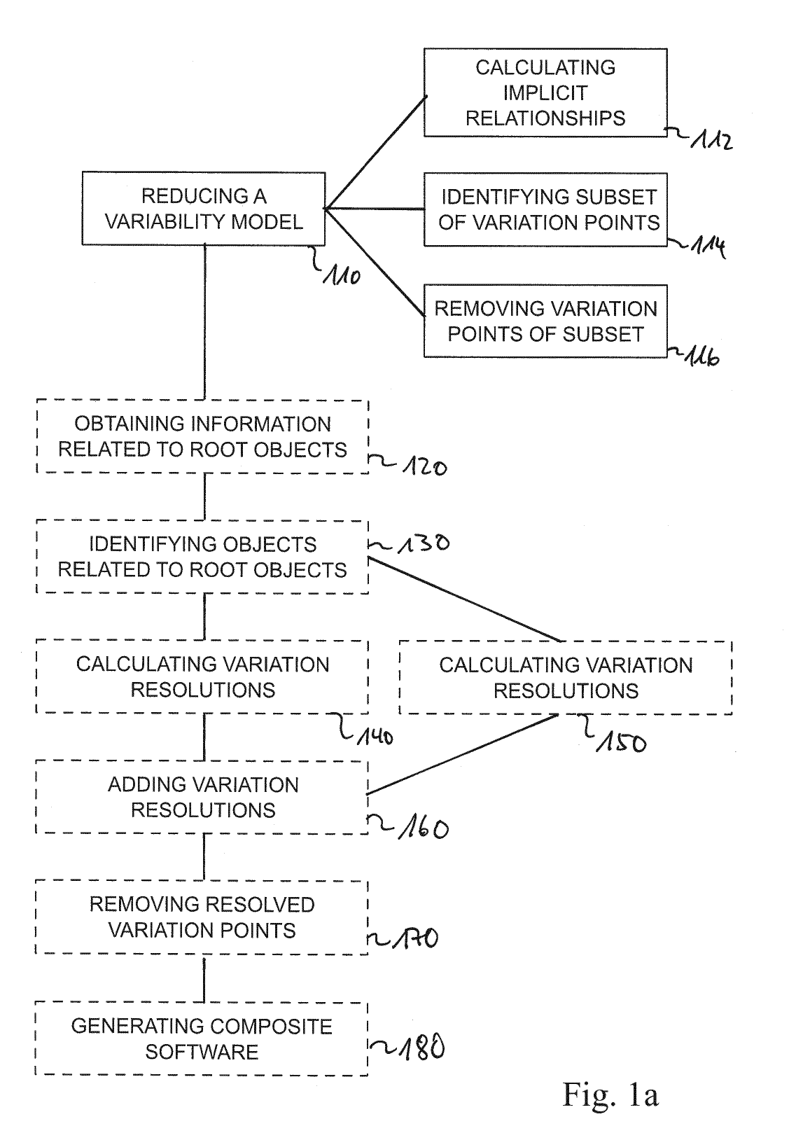

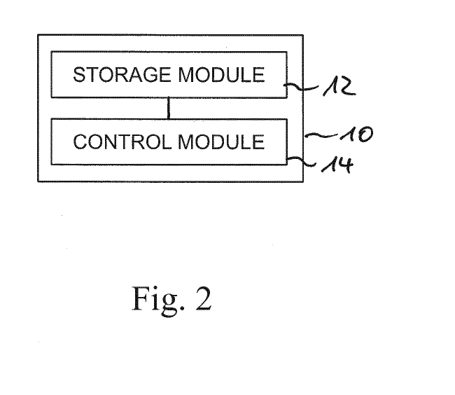

FIG. 1 illustrates a flow chart of a method for reducing a variability model based on a base model, the variability model and a meta model. The method may be suitable for reducing the variability model for a generation of a resolved base model from a plurality of objects of the base model. The variability model and the meta model may be related to the base model. FIG. 2 illustrates a block diagram of an embodiment of a corresponding apparatus for reducing the variability model based on the base model, the variability model and the meta model. The apparatus comprises a storage module 12, configured to store the base model, the variability model and the meta model and a control module 14, configured to execute the method for reducing the variability model based on the base model, the variability model and the meta model.

The following description may relate to both the method of FIG. 1; 1a and the apparatus of FIG. 2.

The base model comprises a plurality of objects and a first plurality of relationships between objects of the plurality of objects. For example, relationships of the first plurality of relationships between objects of the plurality of objects may comprise one of references between objects of the plurality of objects, bindings between objects of the plurality of objects, and mappings between objects of the plurality of objects. For example, the first plurality of relationships between objects of the plurality of objects may comprise one or more binding objects defining one or more relationship between (two or more) objects of the plurality of objects. For example, objects of the base model may correspond to objects of a (software) modeling language/concept, e.g. CVL or the Unified Modeling Language (UML). The base model may correspond to or may be transformed into a product (-specific) model.

The variability model comprises a plurality of variation points. A variation point describes an option within an object of the plurality of objects. A variation point may comprise, represent or correspond to a variation object, for example. For example, a variation point may correspond to or comprise a variation component or a variation component type. For example, a variation component may comprise at least one of a choice of two or more choices and a (e.g. numeric, alphanumeric, binary or Boolean) value. For example, a variation component type may comprise at least one of a choice type for a choice between two or more choices and a value type. The plurality of variation points are related to the plurality of objects by a second plurality of relationships between the plurality of variation points and the plurality of objects. For example, the second plurality or relationships may link the plurality of variation points to the plurality of objects. For example, an object of the plurality of objects may be related to a first variation point corresponding to a variation component (e.g. a choice of two or more choices or a value) and to a second variation point corresponding to a variation component type (e.g. choice of a certain type or value type). For example, a variation component may be related to (exactly) one variation component type, and a variation component type may be related to one or more variation components.

The meta model comprises a plurality of constraints related to the plurality of variation points. The plurality of constraints may be related to the plurality of objects of the base model, for example. For example, the plurality of constraints may be related to at least a subset of objects of the base model related to the plurality of variation points. For example, the plurality of constraints related to the subset of objects of the base model may be applied to the plurality of variation points. For example, the meta model may comprise one or more constraints related to plurality of objects. For example, the meta model may describe entities, relationships and constraints related to the base model. The meta model may describe e.g. classes (objects) and relationships between classes (objects). The meta model may correspond to a generic model, e.g. to a model applicable to more than one (software) product or variant. The meta model may define generic, comprehensive and/or overarching constraints, conventions and/or rules (e.g. for the base model). For example, the meta model may be related to the base model. The meta model may provide a framework for the base model, for example. For example, the meta model may be applicable to a plurality of base models.

For example, the meta model may describe the relationship between variation components and variation component types.

Component * ------- 1 Type

Composition 1------- 1..* Component

For example, one component may be related to exactly one type, and one type may be used by one or more components. Compositions may comprise components. In some embodiments, a composition may not be empty, e.g. it must comprise one or more components. A component may be comprised in (exactly) one composition.

For example, an object model comprising the base model (and, for example, the variability model and/or the meta model) may describe a plurality of variants of a product, e.g. of a vehicle or of a vehicle component.

The method comprises reducing 110 the variability model by calculating 112 implicit relationships between the plurality of variation points based on the plurality of constraints of the meta model. The reducing 110 of the variability model further comprises identifying 114 a subset of variation points of the plurality of variation points implied by other variation points of the plurality of variation points based on the implicit relationships. The reducing 110 of the variability model further comprises removing 116 variation points of the subset of variation points from the plurality of variation points and the variability model.

For example, the plurality of variation points may comprise a plurality of variation components and a plurality of variation component types related to the plurality of variation types. The plurality of constraints may indicate relationships between components of the plurality of variation components and component types of the plurality of variation types. The calculating 112 of the implicit relationships may be based on the relationships between components of the plurality of variation components and component types of the plurality of variation types indicated by the plurality of constraints. For example, the plurality of constraints of the meta model may comprise information related to a (third) plurality of relationships between the plurality of variation components and the plurality of variation component types. For example, the plurality of constraints may define a relationship between variation components (of the plurality of variation components) and variation component types (of the plurality of variation components types). For example, the plurality of constraints may indicate for each variation component (of the plurality of variation components) a variation component type (of the plurality of variation component types).

For example, the method may further comprise removing relationships of the second plurality of relationships related to variation points comprised in the subset of variation points and not related to variation points not comprised in the subset of variation points from the second plurality of relationships. For example, the second plurality of relationships may comprise references between the variation points of the plurality of variation points and the objects of the plurality of objects. For example, (one-to-one) references (relationships) to variation points removed from the plurality of variation points may be removed from the second plurality of relationships.

For example, the method may further comprise reducing the variability model based on one or more explicit choices related to the variation points of the plurality of variation points. For example, the one or more explicit choices may comprise a selection/deselection of variation points of the plurality of variation points. If variation points are deselected, they may be removed from the plurality of variation points, for example. If variation points are deselected, objects of the plurality of objects related to said variation points may be removed from the plurality of objects/the base model. For example, the one or more explicit choices may comprise values or choices for variation points of the plurality of variation points. For example, at least a subset of the plurality of variation points may be resolved based on the explicit choices, moved to the based model and subsequently removed from the plurality of variation points.

FIG. 1a illustrates a flow chart of a method for generating a resolved base model. The method may be implemented similar to or comprise elements of the method described in connection with FIG. 1. The method comprises reducing 110 the variability model. The method may further comprise obtaining 120 information related to one or more root objects of the plurality of objects of the base model. For example, the obtaining 120 of the information related to one or more root objects may be based on one or more explicit choices related to the plurality of objects. For example, the one or more root objects may correspond to objects that must be comprised in the base model. The one or more root objects may correspond to objects of the plurality of objects, for which the resolved base model may be generated.

The method may further comprise identifying 130 objects of the plurality of objects related to the one or more root objects of the base model based on a first plurality of relationships. For example, the identifying 130 of the objects of the plurality of objects related to the one or more root objects of the base model may identify objects directly related to the one or more root objects and objects transitively related to the one or more root objects. For example, the objects transitively related to the one or more root objects may correspond to objects related to objects related to the one or more root objects. For example, the identifying 130 of the objects of the plurality of objects related to the one or more root objects may comprise or correspond to building a (transitive) closure based on the one or more root objects. For example, the objects of the plurality of objects related to the one or more root objects comprise the one or more root objects.

For example, a relationship (e.g. of the first or second plurality of relationships) may comprise at least one of a reference, a mapping and a binding object. For example, a binding object may define a relationship (mapping) between at least one first object and at least one second object. A reference may define a relationship between exactly two objects. For example, the identifying 130 of the objects of the plurality of objects related to the one or more root objects may be based on a reference or a mapping (e.g. by a binding object) between objects. For example, the identifying 130 of the objects of the plurality of objects related to the one or more root objects may be based on parent-child-relationships of the previously identified objects of the plurality of objects related to the one or more root objects. The one or more root objects are related to the one or more root objects, for example.

For example, the method may further comprise removing objects of the plurality of objects (from the plurality of objects and/or from the base model) not related to the one or more root objects. For example, the method may further comprise removing variation points of the plurality of variation points (from the plurality of variation points and/or from the variability model) not (transitively) related to the one or more root objects. For example, the method may further comprise removing an object of the plurality of objects and/or an object of the objects related to the one or more root objects (from the plurality of objects and/or from the base model) based on one or more model constraints (e.g. of the base model or the meta model). In at least some embodiments, objects of the plurality of objects may be comprised in a composition. An object may be comprised in (exactly) one composition, for example. For example, the base model may comprise a plurality of compositions. For example, the method may comprise removing a composition of the plurality of compositions from the plurality of compositions/the base model based on a constraint (of the base model or the meta model, for example). For example, the method may comprise removing a composition of the plurality of compositions from the plurality of compositions/the base model if it is empty (e.g. based on a constraint of the base model or the meta model, for example). For example, a variability of the compositions might not be comprised in the variability model (e.g. omitted from the start), since it may be defined by the meta model.

In other systems (for example), variability resolution may end after computing the product model. At this point, (all) explicit decisions and constraints may have been taken into account. There may however be a high chance that the product model might not yet be in a satisfactory state. There might be unused objects as well as clusters of objects that are not used by other objects. In order to get rid of them, a final garbage collection may be made (e.g. as part of a model reduction). Unused objects may comprise variability objects, e.g. for already resolved variability.

An alternative may be to cover all such objects by the variability model. This may require a thorough analysis of possible selections and of base model content. For objects that are not available in the initial base model as they are created by later model transformations, it might not even be possible. Fortunately, it may not be necessary to spend any such effort as the base model may already comprise (all) relevant information.

Garbage collection or, in other words, model reduction might be done by computing the transitive closure of known root objects and removing all other objects.

In order to perform model reduction, three different kinds of special objects may be distinguished: root objects, binding objects and containers with unrelated objects.

The basis for model reduction may be a set of explicitly required root objects. This set of objects might usually be related to explicitly selected objects in the resolution model but it might not necessarily be the same. The selection may also be made for one or more objects that are computed by model transformations. The resolution model may e.g. comprise selections for software components and the root object for model reduction may be a computed composition that comprises some or all of them.

The set of required objects may recursively be enlarged by referenced objects (e.g. to obtain the objects related to the one or more root objects). Referenced objects may comprise parent objects, e.g. even if there is no explicit backwards reference in the meta model.

An example for a binding object may be a mapping between two or more base model objects. In that case, the reference direction may usually be from the binding object to bound objects without additional backwards references. Binding objects may be identified explicitly, e.g. via their classes. A binding object may be added to the set of required objects if any of its bound objects is contained, for example.

Objects belonging to a container may either be related or unrelated. Containers with related objects may be added to the required objects together with (all) child objects. An example of a container with unrelated objects may be a package or the model root itself. If an object is added to the required objects that belongs to such a container, the container itself may be added but none of the other child objects.

The scope of model reduction may be to get rid of unused objects. To this end, some embodiments might (only) consider the mentioned constraints. Additional constraints defined for the base model as well as variability model constraints might not be taken into account. If this leads to missing intended objects, the completeness of the root selections may be checked, for example.

In some embodiments, model reduction may be a separate step independent from the (preceding) variant resolution step (110). The main reason for this may be a differing scope.

Variant resolution may focus on resolving variability in order to get a consistent intermediate product model. This model may allow to execute further model transformations that depend on an initial variant resolution. The scope of model reduction may be to get rid of unused objects. Another intention might be to extract a subset of an intermediate product model.

Model reduction may be closely related to variant resolution. For example, it may be regarded as a specialized technique of variant resolution and consequently there may also be integrate into variant resolution (110). In that case, the process of variant resolution may be inverted. Instead of taking a full initial base model and then applying decisions and constraints, variant resolution may start with a reduced base model that may (only) comprise the (one or more) root objects. This model may be enlarged by evaluating both variability model and base model constraints. In doing so, (mainly) resolution information may be relevant, that adds objects to the model or modifies existing objects. Constraints that try to remove added objects may be candidates for inconsistencies. How to deal with model reduction may be a project-specific choice, as may be conventions about which constraints are relevant for model reduction.

The method may further comprise calculating 140 variation resolutions for a subset of variation points of the plurality of variation points related to objects of the plurality of objects related to the one or more root objects of the base model. The method may further comprise calculating 150 variation resolutions for implicit variation points implied by the plurality of constraints and variation points of the plurality of variation points related to objects of the plurality of objects related to the one or more root objects of the base model. For example, the implicit variation points may be related to the subset of variation points removed from the plurality of variation points.

For example, the calculating 140 of the variation resolutions for the subset of variation points and/or the calculating 150 of the variation resolutions for the implicit variation points may be based on one or more explicit choices related to the subset of variation points and/or related to the implicit variation points. For example, the one or more explicit choices may comprise values or choices for variation points of the subset of variation points and/or variation points of the implicit variation points. For example, the one or more explicit choices may (directly) resolve variation points of the subset of variation points and/or variation points of the implicit variation points. For example, the one or more explicit choices may select a choice or may specify a value for variation points of the subset of variation points and/or variation points of the implicit variation points.

Additionally or alternatively, the calculating 140 of the variation resolutions for the subset of variation points and/or the calculating 150 of the variation resolutions for the implicit variation points may be based on one or more variation constraints related to the subset of variation points and/or related to the implicit variation points. For example, a variation constraint may imply a choice or value for the variation points of the subset of variation points and/or variation points of the implicit variation points, e.g. due to a lack of alternatives. For example, the calculating 140 of the variation resolutions for the subset of variation points and/or the calculating 150 of the variation resolutions for the implicit variation points may comprise deriving choices, e.g. based on constraints (e.g. of the plurality of constraints or constraints comprised in the base model of variability model) and/or based on explicit choices. For example, the deriving of choices may be based on at least one of choice implication, choice exclusion and parent-child relation. For example, a choice implication may correspond to a selection of a choice for a first variation point, based on an explicit choice or choice derivation for a second variation point. For example, a choice exclusion may correspond to an exclusion of a choice of one or more choices of a first variation point based on an explicit choice or choice derivation of a second variation point. For example, if (only) one choice remains after choice exclusion for a variation point, the one choice may be selected for the variation point. If no choice remains after choice exclusion for a variation point, the variation point may be removed, for example. For example, a variation point may comprise two or more choice options. For example, the deriving of choices may be based on an upper limit or a lower limit of selectable options for the two or more choice options. For example, if a lower limit of selectable options is not reached for a variation point, the remaining selectable options may be selected if, if the remaining selectable options are selected, the lower limit is met. For example, if an upper limit of selectable options is reached for a variation points, the remaining selectable options may not be selected/may be deselected. For example, if an explicit or derived choice exists for a parent variation object, the derived choice may be applied to a child variation object. The parent variation object may be in a parent-child relationship with the child variation object. For example, if the parent variation object is selected, the child variation object may be selected, and if the child variation object is not selected/deselected the parent variation object may be not selected/deselected. For example, the choice implication, the choice exclusion, upper limit and/or lower limit may be based on a constraint (e.g. a base model constraint, a variability model constraint of a meta model constraint (e.g. of the plurality of constraint)) or based on a convention. The calculating 140; 150 of the variation resolutions may provide variation resolutions for the variation points, for which the variation resolutions are calculated. If the calculating 140; 150 of the variation resolution for a variation point is successful, the variation point may correspond to a resolved variation point.

Explicit choices may correspond to choices related to the plurality of variation points based on which the variability model may be reduced and/or the resolved model may be generated. (Model) Constraints may be defined in both the variability model and the base model. Embodiments may provide a combined process of constraint evaluation.

There may be several possibilities to describe constraints and corresponding derivations in the variability model. In CVL there are e.g. ChoiceDerivations and VariableDerivations based on constraints. A constraint may comprise an operator and corresponding literals or references to VSpecs. A simple example is a Choice that implies or excludes another one. Another example is a restricted multiplicity for child selections or an algorithm to determine a variable value.

Variability models may also take usage of dedicated constraint languages like the object constraint language (OCL), for example.

Within the base model (or more precisely its meta model), constraints may be modelled similarly. If a variable object has a mandatory reference to another object, a ChoiceDerivation may be defined. There may also be an object with a lower value of 1 for the number of its child objects. This may also be a ChoiceDerivation meaning the object may not exist if there are no child objects. More complex constraints can be modelled, e.g. by using OCL.

In the following, some examples of choice derivations are given. Derivations for other kinds of VSpecs may be made similarly, for example.

Examples for (choice) derivations (e.g. for the calculation of the variation resolution) via variability model definitions (constraints):
Implication: choiceᵢ.selected→choiceⱼ.selected and in consequence ! choiceⱼ.selected→!choiceᵢ.selected
Exclusion: choiceᵢ.selected→choiceⱼ.selected and in consequence choiceⱼ.selected→! choiceᵢ.selected
Parent-child relations: child.selected→parent.selected and !parent.selected→!child.selected; the child may be a direct child of the parent object or an indirect child in case of composite variability objects like CVSpecs as defined in CVL
Group multiplicity: if there is a lower and/or an upper limit for the number of selectable child choices it may be possible to derive the selection state of not yet decided child choices and/or the selection state of the parent object
   number of selected or still selectable children ≤lower limit→all remaining children may be selected
   number of selected children ≥upper limit→all remaining children may be deselected
   lower limit >0 and all children are deselected→!parent.selected

Various embodiments may further enable derivations (e.g. for the calculation of the variation resolutions) via meta model definitions. The base model's meta model may be an appropriate place for variation information, especially if the variation comprises the existence of an object rather than in having several alternatives from which an explicit selection is required.

The existence of an object may be made dependent on the fulfilment of object constraints. If the constraint is not fulfilled, the object may be removed. This might lead to further constraint violations. In other words, (all) objects might recursively be removed that are invalid because of violated constraints.

Examples for meta model constraints are:
Mandatory references
   Object relation with cardinality ≥1
   Missing container: The container is the parent object in case of an aggregation relation or the model container, e.g. the package
Mandatory attributes
OCL constraints

Mandatory references might be empty because the originally referenced object has been removed during variation resolution. Mandatory attributes may be or become empty because of a missing SlotAssignment or an existing SlotAssignment with a null value. Depending on project specific conventions, violated constraints might (always) lead to object removal or only in case the violation results from variation resolution.

At least some embodiments may further enable (choice) derivations via conventions. In order to reduce the number of variability objects, project specific conventions may be made. There might e.g. be the convention that certain kinds of objects are indirectly selected via composite choices. In that case, such an object might automatically be deselected if none of the composite choices contains a derivation for it. It might also be deselected if all composite choices that comprise a derivation for it are deselected themselves.

Conventions might also be made for the base model. This may be an alternative to formulating all constraints explicitly in the meta model.

The calculation 140; 150 of the variation resolution may comprise a process of computing a resolution model and applying it to the base model. The process may start with explicit decisions and then iteratively evaluate constraints. For model-based systems, a final model reduction step may be used.

Explicit decisions, e.g. selections of choices, may be an initial input for (the calculation of) variation resolution. Variations may be reduced to situations where real choices between alternatives are required. Applying explicit choice resolutions to the base model may usually result in an inconsistent model, as constraints might not have been taken into account.

The majority of variation may be resolved by evaluating constraints. In order to derive (all) possible information, constraints may be evaluated iteratively or via recursion.

It may not be meaningful to distinguish between variability model and base model constraints as they interact. Assuming an object Oi has a mandatory reference to an object Oj. If Oj is removed due to variability model resolution, then Oi may be removed due to a violated base model constraint. If the variability model comprises constraints regarding Oi, there might even be further derivations.

If the constraints are consistent, the resulting product model may be consistent as well. This may be a major difference to other variability resolution approaches that only evaluate the variability model. In that case, the product model may be consistent in regards to variability model constraints but possibly not in regards to further base model constraints.

In order to cope with the situation of inconsistent constraints, priorities may be assigned. It might also be meaningful to define fall back strategies, e.g. the convention to generally keep objects in case of contradictory existence derivations.

In at least some embodiments, the method may further comprise adding 160 the variation resolutions for the subset of variation points and variation resolutions for implicit variation points to the objects of the plurality of objects related to the one or more root objects of the object model. For example, the adding 160 may comprise storing a calculated variation resolution (e.g. a value or a choice) for a resolved variation point within an object related to the resolved variation point. For example, the method may comprise moving the calculated variation resolution and/or variation points, for which the variation resolution have been calculated, from the variability model to the base model.

In various embodiments, the method may further comprise removing 170 the resolved variation points from the plurality of variation points. For example, the removing 170 of the resolved variation points may remove the (resolved) variation points from the variability model and/or the object model.

A model (e.g. base model, variability model) may describe a specific system. It may thus comprise instances of classes (e.g. objects) comprised in the meta model. In an exemplary embodiment, the variability model may comprise three variation components (Component_1, Component_2, Component_3), two component types (Type_1, Type_2) and two Compositions (Composition_1, Composition_2), one (Composition_1) comprising one component (Component_1) and one (Composition_2) comprising two components (Component_2, Component_3). One of the types (Type_2) is related to two components.

Component_1→Type_1
Component_2→Type_2
Component_3→Type_2
Composition_1→Component_1
Composition_2→Component_2, Component_3

In other systems, every variation object may comprise a variation point. To be able to select variation points, they may be related to a choice.

Component_1 is related to variation point VP_1
Component_2 is related to variation point VP_2
Component_3 is related to variation point VP_3
Type_1 is related to variation point VP_4
Type_2 is related to variation point VP_5
Composition_1 is related to variation point VP_6
Composition_2 is related to variation point VP_7
Choice_1 is related to variation point VP_I1
Choice_2 is related to variation point VP_2
Choice_3 is related to variation point VP_3
Choice_4 is related to variation point VP_4
Choice_5 is related to variation point VP_5
Choice_6 is related to variation point VP_6
Choice_7 is related to variation point VP_7

To define the variation within the system, 7 variation points and 7 independent choices may be necessary. To resolve the variation, every choice may be selected or not selected. For example:

Choice_1: not selected
Choice_2: selected
Choice_3: not selected
Choice_4: not selected
Choice_5: selected
Choice_6: not selected
Choice_7: selected

After variation resolution (e.g. of a product model), Composition_2, Component_2 und Type_2 may remain. Other variation objects may be removed due to explicit choices (not selected).

In at least some embodiments, only variation components may be related to variation points. Variation component types might not be related to variation points, as their existence may be implicitly defined by the relationship between variation component and variation component type defined by the meta model (plurality of constraints). Also, compositions may be implicitly derived from the meta model. For example,

Component_1 is related to variation point VP_1
Component_2 is related to variation point VP_2
Component_3 is related to variation point VP_3

This, the variation model may comprise three choices:

Choice_1 is related to variation point VP_1
Choice_2 is related to variation point VP_2
Choice_3 is related to variation point VP_3

### (Resolution Model):

Choice_1: not selected
Choice_2: selected
Choice_3: not selected

During variation resolution (as a first step), explicit choice resolutions may be used. Component_1 and Component_3 are not selected and may be removed from the model, the other objects may remain. In a second step, constraints (e.g. of the plurality of constraints) of the meta model may be used. One constraint (e.g. of the plurality of constraints) may imply, that a composition may comprise at least one component. This constraint may be violated for Composition_1, as Component_1 may be removed from the model. Composition_1 may be removed from the model. After variation resolution, Composition_2, Component_2, Type_1 and Type_2 may be comprised in the model. The model may be consistent, but may comprise Type_1, which may not be required. In a third step of the (model) reduction, a (transitive) closure of required objects may be calculated, (all) other objects may be removed from the model.

The calculation of the closure may start with the explicitly selected (variation) object Component_2. Iteratively, (all) objects may be added, that are related to Component_2, e.g. Type_2 (referenced by Component_2) and Composition_2 (parent object of Component_2). As no other relationships are defined, the calculation of the closure may be finished. Type_1 may be deleted/removed, as it is not comprised in the transitive closure. Composition_2, Component_2 and Type_2 may remain. The result may be the same as in other systems. In contrast, the variability model may be smaller, and only three instead of seven explicit choices had to be made.

In other systems, the variability model may be enriched with additional constraints. For example, the constraints of the meta model might be duplicated in the variability model, which may also lead to three explicit choices. Compared to at least some embodiments, additional processing caused by the additional constraints may make this less efficient.

In other systems, inconsistent decisions may be taken. If Choice_5 is not selected, Type_2 may be removed, although it may be required for Component_2. The possibility of making inconsistent decisions may be directly complied with the (too) large number of explicit choices. The exemplary embodiment, on the other hand, might only allow for three independent choices.

In at least some embodiments, the method may be suitable for a generation of composite software from a plurality of software components. The method may further comprise generating 180 the composite software based on the objects of the plurality of objects related to the one or more root objects, variation points of the variability model related to the objects of the plurality of objects related to the one or more root objects and the meta model. For example, the base model may comprise a plurality of (software) classes related to the plurality of objects, and classes of the plurality of classes may comprise software code or pre-compiled (software) libraries, and the generation of composite software may comprise compiling of the software code and/or linking of compiled software code and/or pre-compiled libraries to obtain the composite software. For example, the generation of the composite software may be based on the resolved variation points. For example, the software may be compiled if (all of) the variation points are resolved. For example, the resolved variation points may correspond to variables, constants or parameters of the composite software. Additionally or alternatively, at least a subset of the resolved variation points may correspond to a choice of software components (e.g. libraries) to be linked for the composite software.

In at least some embodiments, the storage module 12 may comprise at least one element of the group of a computer readable storage medium, such as an magnetic or optical storage medium, e.g. a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage. In embodiments the control module 14 may be implemented using one or more processing units, one or more processing devices, any means for processing, such as a processor, a computer or a programmable hardware component being operable with accordingly adapted software. In other words, the described function of the control module 14 may as well be implemented in software, which is then executed on one or more programmable hardware components. Such hardware components may comprise a general purpose processor, a Digital Signal Processor (DSP), a micro-controller, etc.

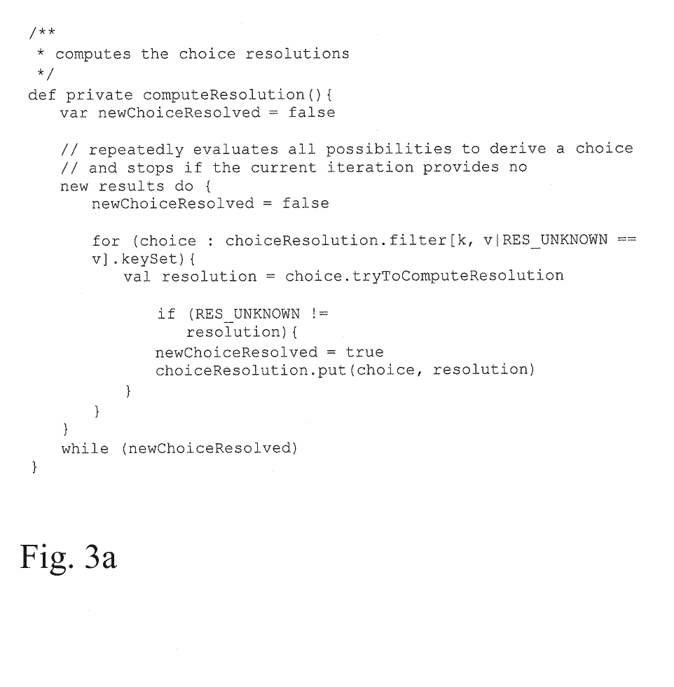

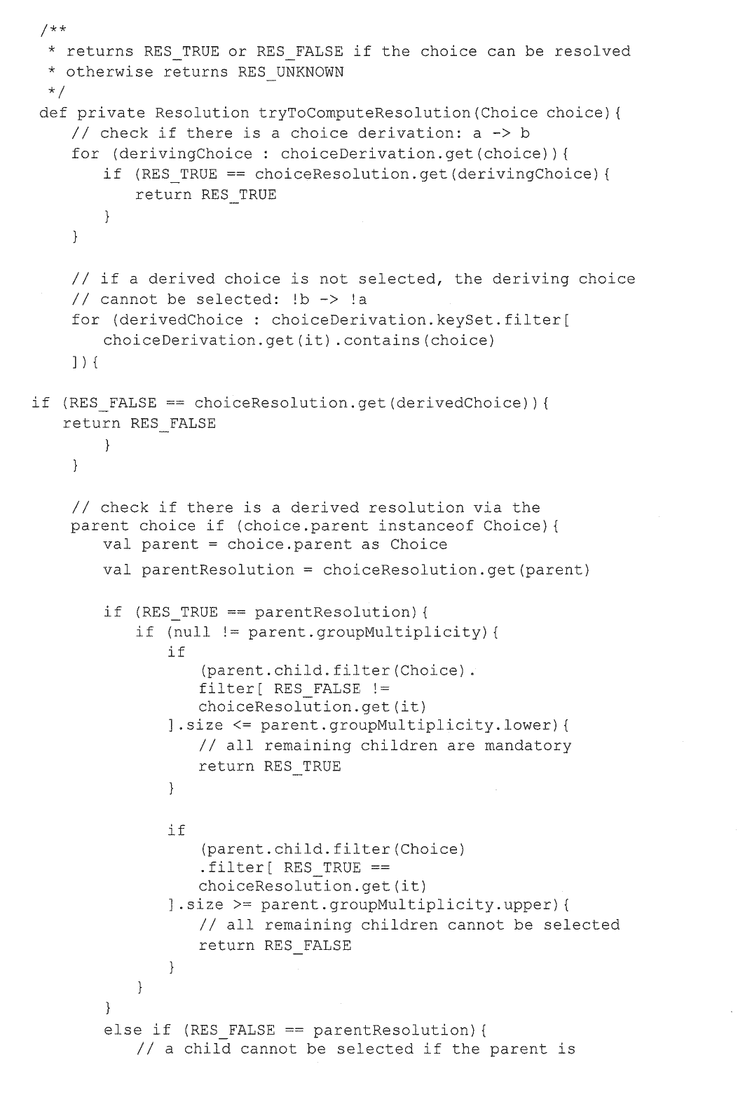

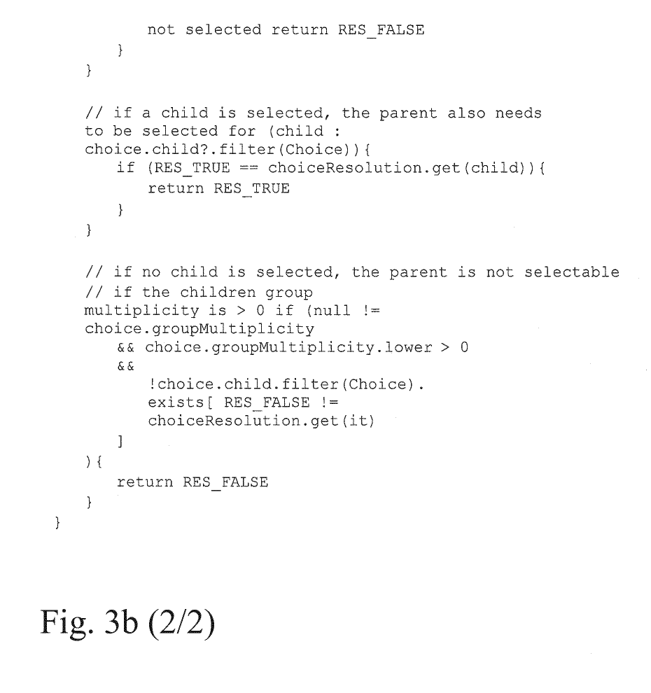

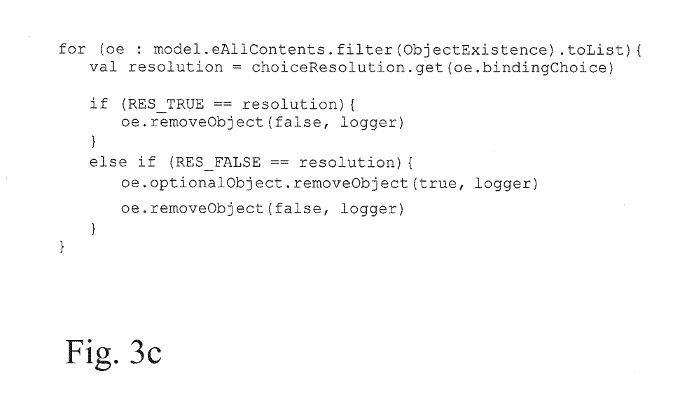

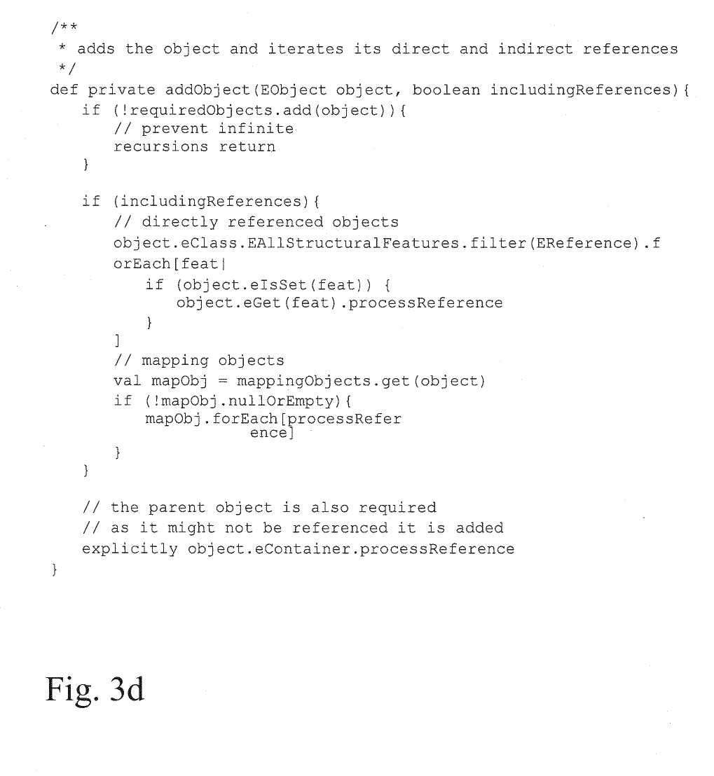

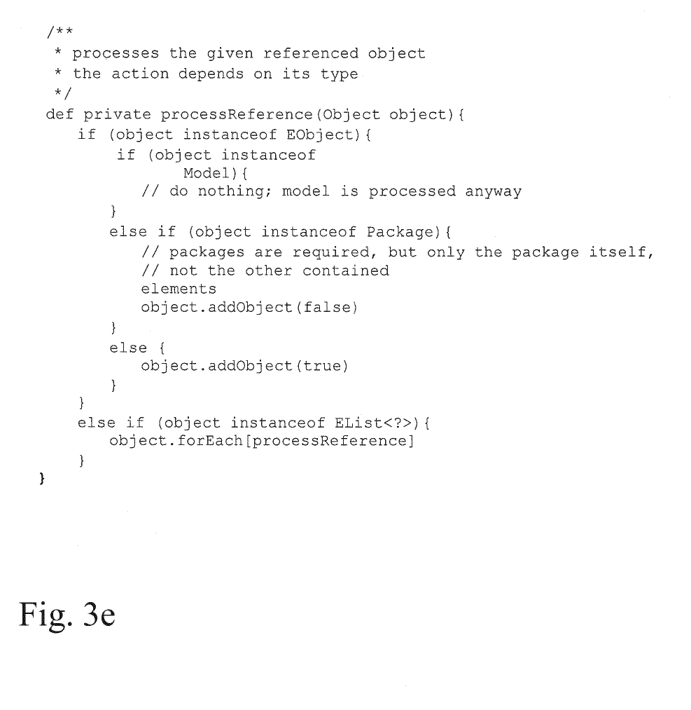

FIGS. 3a-3e show code fragments according to an embodiment. The code fragments may correspond to Xtend code fragments which can be used to process variant handling for Ecore models within the Eclipse Modelling Framework. The code fragments may be used to implement the proposed variant handling approach.

In EMF objects may be removed via

EcoreUtil.delete (EObject eObject, boolean recursive)
which may automatically set (all) references to the removed object to null and may remove (all) child objects if recursive is set to true. It may be more efficient to call the method for containers than to remove objects individually, which may make it worth to implement a corresponding utility class. The following code fragments may use the methods removeObj ect/removeObjects from such an utility class.

FIGS. 3a and 3b show code fragments of an algorithm for choice resolutions according to an embodiment. The algorithm may start with a Map choiceResolution that maps each Choice to a three-value resolution state {RES_TRUE, RES_FALSE, RES_UNKNOWN}. The first two literals may be used if there is an explicit decision available (if the variation is resolved). A Multimap choiceDerivation may be used to map deriving Choices to implied Choices. The resolution model (e.g. to calculate 140; 150 the variation resolution) may be computed iteratively by those two methods:

FIG. 3a shows a code fragment of a function computeResolution, which initiates a calculation of the variation resolution for (all) variation points, which are not resolved (e.g. which comprise the state RES_UNKNOWN. The function computeResolution calls a function tryToComputeResolution of FIG. 3b. The function tryToComputeResolution attempts to derive a resolution of the variation point (e.g. directly via choice implication or via parent-child constraints). The code shows possible derivations, e.g. those that deal with direct choice implication and basic parent-child constraints.

FIG. 3b shows a code fragment related to materialization (adding the variation resolution to the object related to the variation point) according to an embodiment. If a choice is resolved positively, the object may remain, otherwise it may be removed from the model. The ObjectExistence object may (always) be removed to indicate that variation has been resolved.

At least some embodiments may further enable checking object validity in regards to mandatory references. A set of mandatory features may e.g. be determined by:

val mandatoryFeatures=new HashSet<EStructuralFeature> MyModelPackagelmpl.eINSTANCE.EClassifiers.filter (EClass). forEach [mandatoryFeatures+=EAllStructuralFeatures.filter [lowerBound >0]]

Based on the mandatory features, it may be computed if an object is invalid:

object.eClass.EAllStructuralFeatures.exists [

mandatoryFeatures.contains (it) && !object.elsSet (it)

]

Model reduction according to an exemplary embodiment may start with an empty Set requiredObjects, a Set of root objects rootObjects and a Multimap mappingObjects, which maps mapped objects to the mapping objects.

The methods addObject (FIG. 3d) and processReference (FIG. 3e) may recursively add the given object (e.g. comprising (all) referenced objects) to the Set requiredObjects. Each object may be processed (exactly) once.

Root objects (e.g. comprising their closures) may be added to the required objects by calling addObject:

rootObjects.forEach[addObject(true)]

Finally, (all) non-required objects might be removed from the model:

val nonRequiredObjects=model.eAllContents.filter [!requiredObjects.contains(it)
].toList
nonRequiredObjects.removeObjects

In other systems, there may be drawbacks of a strict separation between variability model and base model for variant resolution. Among those may be possible inconsistencies in the resulting product model and the limitation to only attach variability information to objects that are contained in the initial base model. Defining all variability information in a separate variability model may also cause a rather high effort.

For model-based systems, it may be more appropriate to take advantage of implicitly contained variation information within the base model. Combining variability and base model for variability resolution may help to get rid of the mentioned drawbacks and simultaneously reduce the size of the variability model.

At least some embodiments may use the variability model mainly for real choices between alternatives and may instead focus on constraints and conventions. Many constraints, especially those that deal with object existence, may be extracted from the base model, respectively its meta model. Various embodiments may provide a generalized variant resolution approach described that comprises model transformations in between resolutions steps as well as model reduction. Model reduction (garbage collection) may help to get rid of remaining unused objects. Exemplary embodiments may show how model reduction can be made and that there are close similarities to variant resolution.

More details and aspects of method are mentioned in connection with the proposed concept or one or more examples described above (e.g. FIG. 1-2). The method may comprise one or more additional optional features corresponding to one or more aspects of the proposed concept or one or more examples described above or below.

Some embodiments comprise a digital control circuit installed within the apparatus for performing the method. Such a digital control circuit, e.g. a Digital Signal Processor (DSP), needs to be programmed accordingly. Hence, yet further embodiments also provide a computer program having a program code for performing embodiments of the method, when the computer program is executed on a computer, a digital processor, or a programmable hardware component. A further embodiment is a computer readable storage medium storing instructions which, when executed by a computer, processor, or programmable hardware component, cause the computer to implement one of the methods described herein.

A person of skill in the art would readily recognize that steps of various above-described methods can be performed by programmed computers. Herein, some embodiments are also intended to cover program storage devices, e.g., digital data storage media, which are ma-chine or computer readable and encode machine-executable or computer-executable pro-grams of instructions where said instructions perform some or all of the steps of methods described herein. The program storage devices may be, e.g., digital memories, magnetic storage media such as magnetic disks and magnetic tapes, hard drives, or optically readable digital data storage media. The embodiments are also intended to cover computers programmed to perform said steps of methods described herein or (field) programmable logic arrays ((F)PLAs) or (field) programmable gate arrays ((F)PGAs), programmed to perform said steps of the above-described methods.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

Functional blocks denoted as “means for . . . ” (performing a certain function) shall be understood as functional blocks comprising circuitry that is adapted for performing or to perform a certain function, respectively. Hence, a “means for s.th.” may as well be understood as a “means being adapted or suited for s.th.”. A means being adapted for performing a certain function does, hence, not imply that such means necessarily is performing said function (at a given time instant).

The functions of the various elements shown in the Figures, including any functional blocks labeled as “means”, “means for controlling”, “means for transmitting”, “means for receiving”, “means for transceiving”, “means for processing”, etc., may be provided through the use of dedicated hardware, such as “a controller”, “a transmitter”, “a receiver”, “a transceiver”, “a processor”, etc. as well as hardware capable of executing software in association with appropriate software. Moreover, any entity described herein as “means”, may correspond to or be implemented as “one or more modules”, “one or more devices”, “one or more units”, etc. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional or custom, may also be included. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Furthermore, the following claims are hereby incorporated into the Detailed Description, where each claim may stand on its own as a separate embodiment. While each claim may stand on its own as a separate embodiment, it is to be noted that—although a dependent claim may refer in the claims to a specific combination with one or more other claims—other embodiments may also include a combination of the dependent claim with the subject matter of each other dependent claim. Such combinations are proposed herein unless it is stated that a specific combination is not intended. Furthermore, it is intended to include also features of a claim to any other independent claim even if this claim is not directly made dependent to the independent claim.

It is further to be noted that methods disclosed in the specification or in the claims may be implemented by a device having means for performing each of the respective steps of these methods.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for reducing a variability model based on a base model, the variability model and a meta model,
wherein the base model comprises a plurality of objects and a first plurality of relationships between objects of the plurality of objects,
wherein the variability model comprises a plurality of variation points, wherein a variation point describes an option within an object of the plurality of objects,
wherein the plurality of variation points are related to the plurality of objects by a second plurality of relationships between the plurality of variation points and the plurality of objects,
wherein the meta model comprises a plurality of constraints related to the plurality of variation points,
wherein the method comprising:
reducing the variability model by:
calculating implicit relationships between the plurality of variation points based on the plurality of constraints of the meta model,
identifying a subset of variation points of the plurality of variation points implied by other variation points of the plurality of variation points based on the implicit relationships,
removing variation points of the subset of variation points from the plurality of variation points and the variability model.

2. The method according to claim 1, wherein the plurality of variation points comprises a plurality of variation components and a plurality of variation component types related to the plurality of variation types, wherein the plurality of constraints indicate relationship between variation components of the plurality of variation components and variation component types of the plurality of variation types,
wherein said calculating the implicit relationships is based on the relationships between variation components of the plurality of variation components and variation component types of the plurality of variation types indicated by the plurality of constraints.

3. The method according to claim 1, further comprising removing relationships of the second plurality of relationships related to variation points comprised in the subset of variation points and not related to variation points not comprised in the subset of variation points from the second plurality of relationships.

4. The method according to claim 1, further comprising reducing the variability model based on one or more explicit choices related to the variation points of the plurality of variation points.

5. The method according to claim 1, wherein the method is suitable for generating a resolved base model, the method further comprising:
obtaining information related to one or more root objects of the plurality of objects of the base model;
identifying objects of the plurality of objects related to the one or more root objects of the base model based on first plurality of relationships;
calculating variation resolutions for a subset of variation points of the plurality of variation points related to objects of the plurality of objects related to the one or more root objects of the base model;
calculating variation resolutions for implicit variation points implied by the plurality of constraints and variation points of the plurality of variation points related to objects of the plurality of objects related to the one or more root objects of the base model;
adding the variation resolutions for the subset of variation points and variation resolutions for implicit variation points to the objects of the plurality of objects related to the one or more root objects of the object model; and
removing the resolved variation points from the plurality of variation points.

6. The method according to claim 5, wherein the method is suitable for a generation of composite software from a plurality of software components, the method further comprising generating the composite software based on the objects of the plurality of objects related to the one or more root objects, variation points of the variability model related to the objects of the plurality of objects related to the one or more root objects and the meta model.

7. The method according to claim 5, wherein the obtaining the information related to one or more root objects is based on one or more explicit choices related to the plurality of objects.

8. The method according to claim 5, wherein identifying the objects of the plurality of objects related to the one or more root objects is based on a mapping between objects.

9. The method according to claim 5, wherein th calculating of the variation resolutions for the subset of variation points and/or the calculating of the variation resolutions for the implicit variation points is based on one or more explicit choices related to the subset of variation points and/or related to the implicit variation points.

10. The method according to claim 5, wherein calculating the variation resolutions for the subset of variation points and/or the calculating of the variation resolutions for the implicit variation points is based on one or more variation constraints related to the subset of variation points and/or related to the implicit variation points.

11. The method according to claim 5, wherein calculating the variation resolutions for the subset of variation points and/or the calculating of the variation resolutions for the implicit variation points comprises deriving choices.

12. The method according to claim 11, wherein deriving of choices is based on at least one of choice implication, choice exclusion and parent-child relation.

13. The method according to claim 11, wherein a variation point comprises two or more choice options, wherein the deriving of choices is based on an upper limit or a lower limit of selectable options for the two or more choice options.

14. The method according to claim 5, wherein identifying the objects of the plurality of objects related to the one or more root objects is further based on parent-child-relationships of the previously identified objects of the plurality of objects related to the one or more root objects.

15. The method according to claim 5, further comprising moving the variation resolution and/or variation points, for which a variation resolution is calculated, from the variability model to the base model.

16. The method according to claim 5, further comprising removing an object of the plurality of objects and/or an object of the objects related to the one or more root objects based on one or more model constraints.

17. The method according to claim 5, further comprising removing objects of the plurality of objects not related to the one or more root objects.

18. The method according to claim 1, wherein an object model comprising the base model describes a plurality of variants of a vehicle or of a vehicle component.

19. A computer program having a program code for reducing a variability model based on a base model, the variability model and a meta model,
wherein the base model comprises a plurality of objects and a first plurality of relationships between objects of the plurality of objects,
wherein the variability model comprises a plurality of variation points, wherein a variation point describes an option within an object of the plurality of objects,
wherein the plurality of variation points are related to the plurality of objects by a second plurality of relationships between the plurality of variation points and the plurality of objects,
wherein the meta model comprises a plurality of constraints related to the plurality of variation points,
when the computer program is executable by a computer, a processor, or a programmable hardware component to reduce the variability model by:
calculating implicit relationships between the plurality of variation points based on the plurality of constraints of the meta model,
identifying a subset of variation points of the plurality of variation points implied by other variation points of the plurality of variation points based on the implicit relationships,
removing variation points of the subset of variation points from the plurality of variation points and the variability model.

20. An apparatus for reducing a variability model based on a base model, the variability model and a meta model,
wherein the base model comprises a plurality of objects and a first plurality of relationships between objects of the plurality of objects,
wherein the variability model comprises a plurality of variation points, wherein a variation point describes an option within an object of the plurality of objects,
wherein the plurality of variation points are related to the plurality of objects by a second plurality of relationships between the plurality of variation points and the plurality of objects,
wherein the meta model comprises a plurality of constraints related to the plurality of variation points,
the apparatus comprising:
a storage module configured to store the base model, the variability model and the meta model; and
a control module configured to:
reduce the variability model by:
calculating implicit relationships between the plurality of variation points based on the plurality of constraints of the meta model,
identifying a subset of variation points of the plurality of variation points implied by other variation points of the plurality of variation points based on the implicit relationships, and
removing variation points of the subset of variation points from the plurality of variation points and the variability model.
